(19) United States
(12) Patent Application Publication
(10) Pub. No.: US 2026/0216737 A1
(43) Pub. Date: Jul. 30, 2026

(54) CENTRIFUGAL SEPARATOR

(71) Applicant: Alfa Laval Corporate AB, LUND (SE)

(72) Inventor: Kasper HÖGLUND, RÖNNINGE (SE)

(73) Assignee: Alfa Laval Corporate AB, LUND (SE)

(21) Appl. No.: 19/143,494

(22) PCT Filed: Jan. 12, 2024
(86) PCT No.: PCT/EP2024/050688

§ 371 Date: Jun. 26, 2025

(30) Foreign Application Priority Data
Jan. 27, 2023 (EP) 23153798.6

(51) Int. Cl. B04B 1/18

(52) U.S. Cl. CPC B04B 1/18

(57) ABSTRACT

The disclosure concerns a centrifugal separator comprising a rotor with a rotor body provided with outlet openings and a slide arranged within the rotor body for closing the outlet openings. An operating chamber is provided between the axially movable slide and the rotor body for receiving an operating liquid to displace the slide. An operating liquid discharge channel extends in the rotor body from the operating chamber to an exterior space. A pilot valve is arranged in the rotor body to close and open the operating liquid discharge channel, and a control liquid channel extends to the pilot valve for supplying a control liquid thereto. A portion of the control liquid channel extends through the valve body.

### TECHNICAL FIELD

The invention relates to a centrifugal separator.

### BACKGROUND

Various kinds of continuously operating centrifugal separators for separating solids and/or sludge from a liquid or liquid mixture are known. A high speed centrifugal separator comprises a rotor that is rotated about a vertical rotational axis in use of the separator. One kind of centrifugal separator is devised for intermittent discharge of solids and/or sludge.

Solids and/or particles containing liquid or liquid mixture to be separated is introduced into a separation space of the rotor while the rotor rotates. Solids, particles, and/or sludge are transported by centrifugal force towards a periphery of the separation space, from where they are discharged through outlet openings from the separation space in a body of the rotor.

Opening and closing the outlet openings from the separation space is controlled by an axially movable slide forming a lower limitation of the separation space. The axially movable slide may be referred to as sliding bowl bottom, piston valve, or similar. A pilot valve may be used for controlling the axially movable slide. The pilot valve is small and operates with low force in comparison with the axially movable slide.

As e.g. disclosed in DE 3133689, the rotor comprises at a lower portion thereof an axially slidably mounted piston valve, which in an upper position closes the outlet openings and in a lower position opens the outlet openings. A closing chamber below the piston valve is filled with a liquid, referred to as closing liquid or sealing liquid, in order to move or maintain the piston valve in its upper position. When the closing chamber is emptied of the closing liquid, the piston valve moves to its lower position thus, opening the outlet openings. A fluid-driven centrifugal valve arranged in the body of the rotor is provided for emptying the closing chamber. Accordingly, the fluid-driven centrifugal valve forms a pilot valve for the piston valve. An inlet conduit connects to the centrifugal valve and is arranged to lead a control fluid to a valve cone of the centrifugal valve. The inlet conduit connects at a longitudinal side of the centrifugal valve to supply control fluid to the valve cone for moving it in a direction radially towards the rotational axis.

When the rotor rotates, the centrifugal force acting on the valve cone forces it radially outwardly from the rotational axis and a discharge channel from the closing chamber is maintained closed. Thus, the closing liquid in the closing chamber remains therein. In order to empty the closing chamber for the piston valve to open, control fluid is lead to the valve cone for forcing it against the centrifugal force radially towards the rotational axis. Thus, the discharge channel from the closing chamber is opened and the closing liquid is drained from the closing chamber.

U.S. Pat. No. 4,410,317 discloses a self-discharging centrifugal drum of a centrifugal separator of the above discussed kind. Again, a closure compartment that can be charged with closure fluid is disposed below the piston valve and into which the closure fluid is supplied through a channel that is connected to an intermediate compartment for closure fluid. The closure compartment is evacuated to initiate discharge of solids/sludge by a centrifugal valve. Again, the valve that evacuates the closure compartment is a centrifugal valve that contains a movable valve cone, with the valve cone activated by control fluid. The valve cone has a valve projection that is smaller in diameter than the valve cone and that is sealed into the drum jacket behind the valve cone so that the valve projection will extensively choke or close a channel that connects the closure compartment to the intermediate compartment when the valve cone is moved to its open position. Accordingly, the channel, which is arranged radially inwardly of, and concentrically with, the valve cone is flowed through by closure fluid.

### SUMMARY

It would be advantageous to achieve an alternative arrangement for controlling an axially movable slide of a centrifugal separator. In particular, it would be desirable to enable a precise control of an axially movable slide of a centrifugal separator. To better address one or more of these concerns, a centrifugal separator having the features defined in the independent claim is provided.

According to an aspect of the invention, there is provided a centrifugal separator comprising a rotor arranged to rotate about a rotational axis having an axial extension, wherein the rotor comprises a rotor body provided with outlet openings arranged at a periphery of the rotor body and an axially movable slide arranged within the rotor body for closing the outlet openings in a first axial position and opening the outlet openings in a second axial position. A separation space is provided within the rotor, wherein in the second axial position of the axially movable slide, the outlet openings fluidly connect the separation space with an ambient space outside the rotor. An operating chamber is provided between the axially movable slide and the rotor body for receiving an operating liquid to displace the axially movable slide from its second axial position to its first axial position, an operating liquid discharge channel extends in the rotor body from the operating chamber to an exterior space of the rotor, a pilot valve is arranged in the rotor body to close and open the operating liquid discharge channel, and a control liquid channel extends at least partially through the rotor body to the pilot valve for supplying a control liquid to the pilot valve. The pilot valve comprises a valve body having a longitudinal axis, the valve body being movable in parallel with the longitudinal axis from a first radial position to a second radial position under influence of the control liquid. The control liquid channel extends to an actuation pressure receiving area of the valve body. A portion of the control liquid channel extends through the valve body to the actuation pressure receiving area.

Since a portion of the control liquid channel extends through the valve body to the actuation pressure receiving area, a length of the control liquid channel through the rotor body and to the actuation pressure receiving area of the valve body is kept short. Thus, a total volume of the control liquid channel is smaller than the volume of a corresponding control liquid channel that leads through the rotor body laterally from the pilot valve to the actuation pressure receiving area of the valve body. The small volume of the control liquid channel leads to a more responsive control of the pilot valve in comparison with one that is supplied with control liquid from a control liquid channel that has a larger volume. Accordingly, a precise control of the pilot valve is achieved and with that also a precise control of the axially movable slide for opening and closing the outlet openings from the separation space.

Moreover, the arrangement with a portion of the control liquid channel extending through the valve body means that this portion of the control liquid channel and the portion of the control liquid channel leading up to that portion may extend in line with each other or at only a slight angle to each other. Accordingly, manufacturing of the control liquid channel is facilitated in comparison with a control liquid channel that leads through the rotor body laterally from the pilot valve to the actuation pressure receiving area of the valve body. A control liquid channel of the latter kind is e.g., drilled from a multiple of different directions through the rotor body, which requires plugging of portions of the drillholes forming the control liquid channel.

With the portion of the control liquid channel extending through the valve body and the control liquid channel and the portion of the control liquid channel leading up to that portion extending in line or only at a slight angle, drilling of the control liquid channel through the rotor body may only have to be done in one direction or a limited number of directions. Also, no plugging of any portions of the drillhole/s may be required.

The centrifugal separator is a high-speed centrifugal separator i.e., the rotor rotates at several thousand rotations per minute, such as at 3000-12000 rpm, during use of the centrifugal separator.

The rotor may be arranged inside a stationary housing of the centrifugal separator. The rotor may be driven to rotate about the rotational axis by a drive arrangement comprising e.g., an electric motor.

When the centrifugal separator is positioned for use thereof, the axial extension of the rotational axis may extend in a vertical direction. Accordingly, the rotor may have an upper portion and a lower portion.

Herein, the terms axial, radial, and rotational relate to the rotational axis. An axial direction extends in parallel with the rotational axis of the rotor and a radial direction extends perpendicularly to the rotational axis. A rotational direction extends around the rotational axis.

Herein, the axially movable slide is also referred to as the slide. The first and second axial positions of the slide may be opposite axial end positions of a range of movement of the slide.

The rotor body of the rotor may comprise one or more separate parts. The axially movable slide may delimit at least part of a lower portion of the separation space.

During use of the centrifugal separator, separation of a liquid feed mixture is performed in the separation space of the centrifugal separator. A separation aid e.g., comprising a stack of frustoconical separation discs, may be arranged in the separation space.

During use of the centrifugal separator, the liquid feed mixture is led into the separation space along the rotational axis. A separated light phase is led out of the separation space along the rotational axis or radially close to the rotational axis. A sludge phase is separated from the liquid mixture and is discharged through the outlet openings. According to some embodiments, a separated heavy phase may be led out of the separation space along the rotational axis or radially close to the rotational axis.

The sludge phase contains liquid with heavy solid particles and/or heavy liquid particles of a different liquid suspended therein. The sludge phase is separated in a peripheral portion of the separation space and is discharged from the separation space when the slide is in its second axial position and accordingly, the outlet openings are open.

During use of the centrifugal separator, when the slide is in the second axial position, the sludge phase is discharged into the ambient space outside the rotor via the outlet openings. The ambient space may be provided between the rotor and the stationary housing of the centrifugal separator. The discharged sludge phase is led from the ambient space via suitable means.

During use of the centrifugal separator, when separation of the liquid feed mixture takes place, the axially movable slide is in its first axial position and thus, the outlet openings are closed. The slide is held in the first axial position by the operating liquid in the operating chamber. Intermittently, when separated sludge phase is to be discharged from the separation space, the pilot valve is opened. As a result, the operating chamber is at least partially emptied of operating liquid via the operating liquid discharge channel to the exterior space of the rotor, the slide is moved to its second axial position, and the outlet openings are opened.

Depending on a duration of the pilot valve being open, a partial discharge of contents of the separation space or a full discharge of the contents of the separation space is achieved. In a partial discharge, some or all of the separated sludge phase is discharged from the separation space. During a partial discharge, a liquid interphase between separated liquid phases of different densities within the separation space essentially, may be maintained. In a full discharge the interface ruptures and has to form again after completion of the discharge.

The slide is moved back from the second axial position to the first axial position by closing the pilot valve and filling the operating chamber with operating liquid again.

Movements of the slide between its first and second axial positions and vice versa, may not require a complete emptying of, or complete filling with, operating liquid of the operating chamber. When a threshold pressure is reached within the operating chamber, the slide moves to the first or second axial position. At the threshold pressure, operating liquid may partially fill the operating chamber.

In a known manner, a source of operating liquid may be connected to the operating chamber. Also, the operating liquid discharge channel may be dimensioned such that discharge of operating liquid operating chamber exceeds inflowing operating liquid when the operating liquid discharge channel is open. Thus, the operating chamber is drained quicker via the operating liquid discharge channel than refilled from the source of operating liquid when the pilot valve is opened to move the slide from its first axial position to its second axial position and a quick refilling of the operating chamber may be ensured as soon as the pilot valve closes.

The exterior space of the rotor may be arranged between the rotor and the stationary housing of the centrifugal separator. The exterior space may form part of the ambient space. Accordingly, the sludge phase and the operating liquid may be discharged into the same space outside the rotor.

The pilot valve is a small valve in comparison with the valve formed by the axially moveable slide. The pilot valve requires a much smaller force to operate than the axially movable slide. The pilot valve “pilots” the axially movable slide utilising a comparatively small flow of control liquid in comparison with the flow of operating liquid utilised for opening and closing the valve slide.

During use of the centrifugal separator, when the control liquid is supplied to the actuation pressure receiving area of the valve body of the pilot valve, a pressure is built up in a control chamber bordering to the actuation pressure receiving area. When the pressure is high enough in the control chamber, the pressure actuates the valve body via the actuation pressure receiving area and the valve body is displaced from its first radial position to its second radial position and the operating liquid discharge channel is opened.

To clarify, the actuation pressure receiving area of the valve body is that portion of the valve body, which when the valve body is affected by the pressure of the control liquid provides the resulting force that causes the valve body to move from its first to its second radial position for opening the pilot valve. Accordingly, seen along the longitudinal axis radially inwardly from the pressure receiving area, a space is provided. When the valve body is in its first radial position the space is empty. When in its second position, the valve body is at least partially positioned in this space.

For instance, the first radial position may be at a larger radius of the rotor than the second radial position.

The valve body may be arranged such that, centrifugal force returns the valve body to its first radial position to close the operating liquid discharge channel. As a complement or alternative, the valve body may be biased towards its first radial position.

The control liquid is supplied to the pilot valve via the control liquid channel when the pilot valve is to be opened and accordingly, when the valve body is to be moved from the first to the second radial position. When the pilot valve is to be closed again, supply of control liquid is stopped, and the control chamber is drained of control liquid.

According to embodiments, the control liquid channel may extend partially through the valve body concentrically with the longitudinal axis of the valve body. In this manner, the control liquid channel upstream of the valve body may fluidly communicate with the portion of the control liquid channel extending through the valve body. This may contribute to a short and low volume control liquid channel.

Moreover, this may provide for fluid connection to the actuation pressure receiving area extending through the valve body, which again, may contribute to the short and low volume control liquid channel.

Further, the control liquid channel extending at least partially through the valve body concentrically with the longitudinal axis of the valve body means that the control liquid channel may extend through the pressure receiving area, such as concentrically with the pressure receiving area. This may contribute to control liquid being efficiently distributed from the control liquid channel over the entire pressure receiving area.

According to embodiments, a guide member may guide the movement of the valve body between the first and second radial positions. In this manner, it may be ensured that the valve body is displaceable between the first and second radial positions in a smooth manner.

For instance, an angular displacement of the valve body in relation to an intended traveling direction parallel with the longitudinal axis may be avoided. Thus, the valve body will not be subjected to accidental pinching within a bore, in which the valve body travels between the first and second positions.

According to embodiments, the guide member may be provided with a through opening fluidly connecting the control liquid channel with the exterior space, wherein the through opening has a smaller cross sectional area than the control liquid channel within the guide member. In this manner, a control chamber at the actuation pressure receiving area may be drained via the guide member when the pilot valve is to close again after having been opened. Moreover, due to the smaller cross-sectional area of the through opening in comparison with that of the control liquid channel, the control chamber may be filled with control liquid, and the pressure therein increased, to affect the actuation pressure receiving area when opening the pilot valve. Namely, the smaller cross-sectional area forms a restriction which causes the control liquid to fille the control chamber.

According to embodiments, a portion of the valve body in its first radial position may abut against a sealing surface arranged in the rotor. The portion of the valve body and the sealing surface form a sealing interface of the operating liquid discharge channel. In this manner, the pilot valve may be configured for sealing closing the operating liquid discharge channel.

Further features of, and advantages with, the invention will become apparent when studying the appended claims and the following detailed description.

### BRIEF DESCRIPTION OF THE DRAWINGS

Various aspects and/or embodiments of the invention, including its particular features and advantages, will be readily understood from the example embodiments discussed in the following detailed description and the accompanying drawings, in which:

FIG. 1 schematically illustrates a cross section through a centrifugal separator according to embodiments,

FIGS. 2a and 2b schematically illustrate cross sections through a portion of a centrifugal separator,

FIGS. 3a and 3b schematically illustrate cross sections through a pilot valve according to embodiments, and

FIG. 4 schematically illustrates a cross section through a portion of a pilot valve 40 of a centrifugal separator according to embodiments.

### DETAILED DESCRIPTION

Aspects and/or embodiments of the invention will now be described more fully. Like numbers refer to like elements throughout. Well-known functions or constructions will not necessarily be described in detail for brevity and/or clarity.

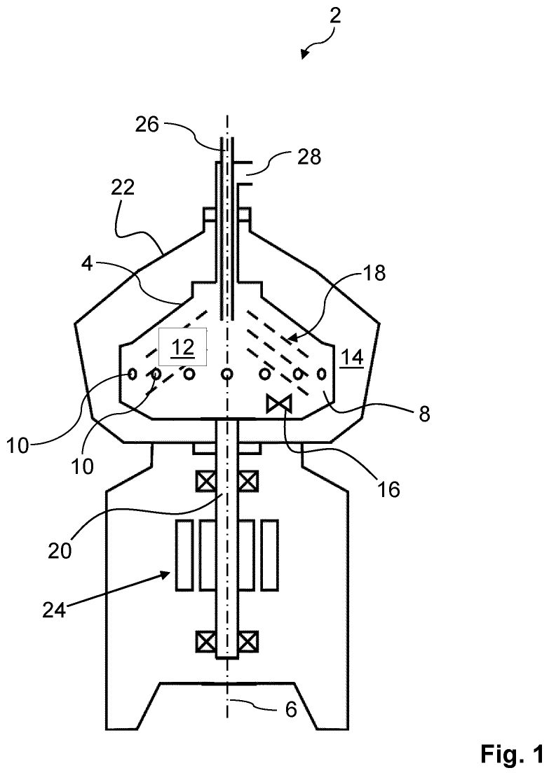

FIG. 1 schematically illustrates a cross section through a centrifugal separator 2 according to embodiments.

The centrifugal separator 2 comprises a rotor 4 arranged to rotate about a rotational axis 6. The rotational axis 6 has an axial extension. The rotor 4 comprises a rotor body 8 provided with outlet openings 10. That is, the outlet openings 10 extend through the rotor body 8. The outlet openings 10 are arranged at a periphery of the rotor body 8.

A separation space 12 is provided within the rotor 4. The outlet openings 10 are evenly distributed around the periphery of the rotor 4 and are arranged for intermittent discharge of at least a sludge phase separated in the separation space 12.

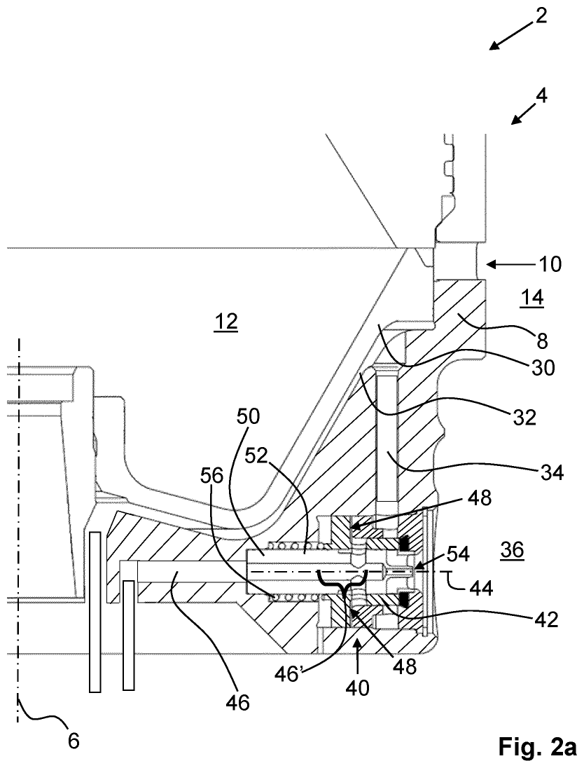

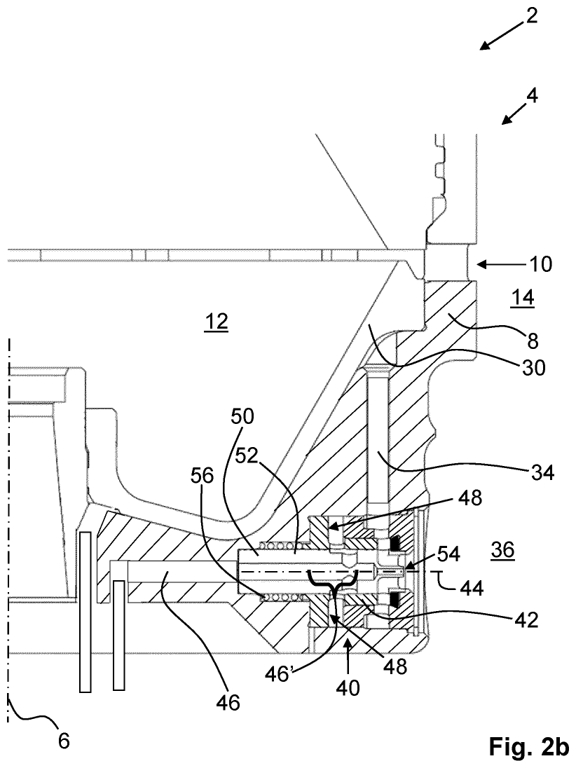

The outlet openings 10 are intermittently openable by movement of an axially movable slide (not shown) within the rotor 4, see further below with reference to FIGS. 2a and 2b. When open, the outlet openings 10 fluidly connect the separation space 12 with an ambient space 14 outside the rotor 4.

The outlet openings 10 may be opened when needed and/or at equal time periods for all or part of a content of the separation space 12 to be partially or fully discharged.

A pilot valve 16 is arranged in the rotor body 8. The pilot valve 16 controls the movement of the axially movable slide and thus, the opening and closing of the outlet openings 10, see further below with reference to FIGS. 2a-4.

A separation aid in the form of a stack 18 of frustoconical separation discs is arranged in the separation space 12. Other kinds of separation aids e.g., radially extending vanes may alternatively be arranged in the separation space 12.

The rotor 4 is supported by and driven by a spindle 20. The rotor 4 is rotatably arranged inside a stationary housing 22 of the centrifugal separator 2.

In these embodiments, the ambient space 14 is formed within the stationary housing 22. The sludge phase is conducted out from the ambient space 14 via a non-shown outlet conduit.

The spindle 20 and the rotor 4 are driven to rotate about the rotational axis 6 by a drive arrangement comprising an electric motor 24. In the illustrated embodiments, the spindle 20 is directly driven by the electric motor 24. In alternative embodiments, a transmission may be arranged between the electric motor and the spindle.

An inlet 26 for a liquid feed mixture to be separated in the centrifugal separator 2 leading into the separation space 12 is arranged at an upper end of the rotor 4. Alternatively, the liquid feed mixture may be led into the separation space 12 via a hollow spindle from below the rotor 4.

An outlet 28 for separated liquid light phase is arranged at an upper end of the rotor 4. Alternatively, the liquid light phase may be led from the separation space via a hollow spindle downwardly from the rotor 4.

Optionally, there may be provided a further outlet (not shown) for a separated liquid heavy phase arranged at an upper or lower end of the rotor 4.

FIGS. 2a and 2b schematically illustrate cross sections through a portion of a centrifugal separator 2. The centrifugal separator 2 may be a centrifugal separator 2 as discussed above with reference to FIG. 1. Accordingly, in the following reference is also made to FIG. 1.

Again, the centrifugal separator 2 comprises a rotor 4 arranged to rotate about a rotational axis 6. The rotor 4 comprises a rotor body 8 provided with outlet openings 10. A separation space 12 is provided within the rotor 4.

An axially movable slide 30 is arranged within the rotor body 8. The slide 30 is arranged for closing the outlet openings 10 in a first axial position as shown in FIG. 2a. The slide 30 is arranged for opening the outlet openings 10 in a second axial position of the slide 30 as shown in FIG. 2b.

In the first axial position, the slide 30 abuts sealingly at its periphery against an upper part of the rotor body 8, thereby closing the separation space 12 from fluid connection with the outlet openings 10 and the ambient space 14 outside the rotor 4.

In the second axial position, the slide 30 is positioned such that the outlet openings 10 fluidly connect the separation space 12 with the ambient space 14.

An operating chamber 32 is provided between the slide 30 and the rotor body 8. In these embodiments, the operating chamber 32 is provided below the slide 30 between the slide 30 and a lower portion of the rotor body 8. The operating chamber 32 is arranged for receiving an operating liquid to displace the axially movable slide 30 from its second axial position to its first axial position. The operating liquid may be supplied via an operating liquid supply system from a radially inner portion of the rotor 4.

The operating liquid may be water.

An operating liquid discharge channel 34 extends in the rotor body 8 from the operating chamber 32 to an exterior space 36 of the rotor 4. The exterior space 36 may form part of the ambient space 14 or it may be delimited from the ambient space 14.

A pilot valve 40 is arranged in the rotor body 8 to close and open the operating liquid discharge channel 34. The pilot valve 40 comprises a valve body 42 which is movable in relation to the rotor body 8. The valve body 42 has a longitudinal axis 44. The valve body 42 is movable in parallel with the longitudinal axis 44 from a first radial position to a second radial position within the rotor body 8. The first radial position of the valve body 42 is shown in FIG. 2a when the slide 30 is in its first axial position. The second radial position of the valve body 42 is shown in FIG. 2b when the slide 30 is in its second axial position.

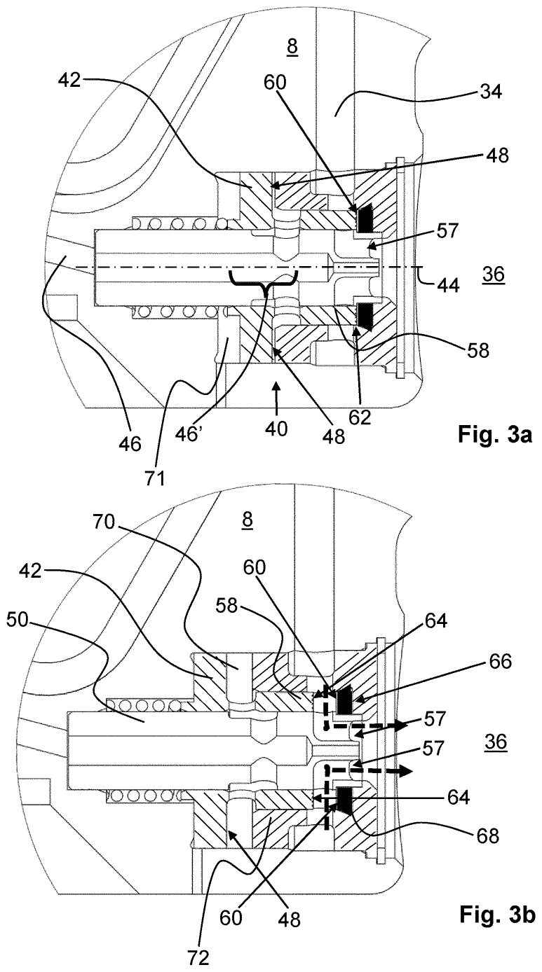

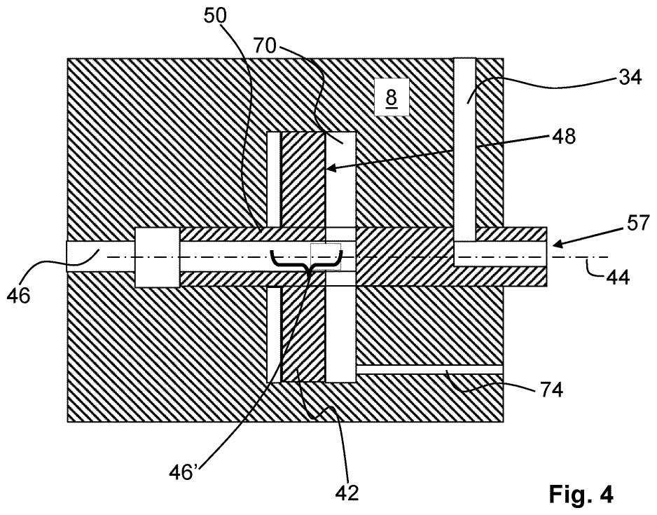

Certain aspects of the pilot valve 40 will also be discussed below with reference to FIGS. 3a and 3b.

The first radial position of the valve body 42 is at a larger radius than the second radial position. The longitudinal axis 44 may extend in a radial direction as in the illustrated embodiments. Alternatively, the longitudinal axis 44 may extend at an angle to the radial direction. Still, the first radial position of the valve body 42 will be at a larger radius than the second radial position.

Accordingly, the valve body 42 is arranged to move between first and second radial positions for opening and closing the operating liquid discharge channel 34. In the first radial position of the valve body 42, the operating liquid discharge channel 34 is closed and operating liquid fills the operating chamber 32 and the operating liquid discharge channel 34, at least to a substantial degree. In the second radial position of the valve body 42, the operating liquid discharge channel 34 is open and operating liquid is discharged from the operating chamber 32 and the operating liquid discharge channel 34.

A control liquid influences the movement of the valve body 42, at least in the direction from the first to the second radial position.

The control liquid may be water.

A control liquid channel 46 extends at least partially through the rotor body 8 to the pilot valve 40 for supplying the control liquid to the pilot valve 40. The control liquid channel 46 extends to an actuation pressure receiving area 48 of the valve body 42. A portion 46′ of the control liquid channel 46 extends through the valve body 42 to the actuation pressure receiving area 48.

For instance, seen in a view along the longitudinal axis 44, the valve body 42 may have a round shape with a central hole for the control liquid channel 46 to pass therethrough.

The valve body 42 is movable in relation to the rotor body 8. When a pressure of the control liquid within the control liquid channel 46 is sufficiently high, the pressure affecting the actuation pressure receiving area 48 produces a force that moves the valve body 42 from its first to its second radial position.

The control liquid may be fed from a control liquid source to the control liquid channel 46 from a radially inner portion of the rotor 4.

The control liquid channel 46 is kept short due to it passing through the valve body 42 to the actuation pressure receiving area 48. The short length entails a small volume and thus, a rapid response of the valve body 42 when control liquid is supplied to the pilot valve 40.

Also, as can be seen in the cross sections of FIGS. 2a and 2b, the arrangement with a portion 46′ of the control liquid channel 46 extending through the valve body 42 means that manufacturing of the control liquid channel 46 in the rotor body 8 can be perform by one drilling operation or a limited number of drilling operations. Accordingly, manufacturing of the control liquid channel 46 is easy.

More specifically, the control liquid channel 46 may have a radial direction through the rotor body 8 or it may be arranged at a slight angle, such as at 1-30 degrees to the radial direction. This means that the control liquid channel 46 upstream of the pilot valve 40 may connect to the pilot valve 40 from a radial position inside the pilot valve 40. Also, part of the control liquid channel 46 may be manufactured by a drilling operation through part of the rotor body 8 from radially outside the rotor body 8.

According to embodiments, such as the illustrated embodiments, the control liquid channel 46 may extend through the rotor body 8 radially inwardly from the portion 46′ of the control liquid channel 46 extending through the valve body 42. In this manner, the control liquid channel 46 may connect in a straight line with the longitudinal axis 44 of the valve body 42 or at a slight angle, such as at an angle within a range of 1-30 degrees to the longitudinal axis 44. Thus, the above discussed easily manufacture and short and low volume control liquid channel 46 may be provided.

In the illustrated embodiments, the control liquid channel 46 extends partially through the valve body 42 concentrically with the longitudinal axis 44 of the valve body 42. That is, the portion 46′ of the control liquid channel 46 extending through the valve body 42 extends concentrically with the longitudinal axis 44. Thus, the control liquid channel 46 upstream of the valve body 42 is easily arranged to directly communicate with the portion 46′ of the control liquid channel 46 extending through the valve body 46.

According to embodiments, such as the illustrated embodiments, a guide member 50 guides the movement of the valve body 42 between the first and second radial positions.

In these embodiments, the guide member 50 is fixed in relation to the rotor body 8 and may comprise a pin arranged in a hole of the valve body 42.

Additionally, the valve body 42 may be guided by a bore in the rotor body 8 or in a sleeve e.g., forming part of the pilot valve 40.

According to embodiments, such as in the illustrated embodiments, the control liquid channel 46 extends partially through the guide member 50. In this manner, at least the portion 46′ of the control liquid channel 46 extending through the valve body 42 may conveniently be provided in the guide member 50.

According to embodiments, such as in the illustrated embodiments, the operating liquid discharge channel 34 extends partially through the guide member 50. In this manner, the valve body 42 may be supported at a portion thereof by the guide member 50 where the valve body 42 is arranged to control the flow of the operating liquid through the operating liquid discharge channel 34.

According to embodiments, such as in the illustrated embodiments, the guide member 50 is fixed in relation to the rotor body 8 and comprises a central pin 52 on which the valve body 42 is slidably arranged.

The central pin 52 may be a separate pin mounted in the rotor body 8, as in the illustrated embodiments. Alternatively, at least a portion of the central pin 52 may form an integral part of the rotor body 8.

The guide member 50 is provided with a through opening 54 fluidly connecting the control liquid channel 46 with the exterior space 36. The through opening 54 has a smaller cross-sectional area than the control liquid channel 46 within the guide member 50.

The control liquid channel 46 is thus, drained via the through opening 54 when the pilot valve 40 is to close i.e., when the valve body 42 is to move from the second radial position to the first radial position. More specifically, when a supply of control liquid stops, the control liquid in the control liquid channel 46 and at the actuation pressure receiving area 48 flows out of the pilot valve 40 via the through opening 54 into the exterior space 36.

During opening of the pilot valve 40 when control liquid is supplied to the control liquid channel 46 and the actuation pressure receiving area 48, the smaller cross-sectional area of the through opening 54 forms a restriction which causes the control liquid to a mass in the control liquid channel 46 and at the actuation pressure receiving area 48. Accordingly, the response of the pilot valve 40 may be controlled by the dimensions of the control liquid channel 46 and the through opening 54 and the flow rate, at which the control fluid is supplied to the control liquid channel 46.

According to embodiments, the valve body 42 may be biased towards the first radial position to close the operating liquid discharge channel 42. In this manner, when supply of control liquid to the control liquid channel 46 stops and it is drained of control liquid, it is ensured that the valve body 42 returns to its first radial position. Such bias may also ensure that valve body 42 is in its first radial position when the rotor 4 does not rotate.

In the illustrated embodiments, a biasing member 56, such a compression spring, biases the valve body 42 towards the first radial position.

During use of the centrifugal separator 2, a pressure of the control liquid supplied to the actuation pressure receiving area 48 when the valve body 42 is to be moved from its first to its second radial position has to overcome not only the centrifugal force of the rotor rotation affecting the valve body 42 but also the biasing force of the biasing member 56.

During use of the centrifugal separator 2, as mentioned, the rotation of the rotor 4 affects the rotor body 42 with a centrifugal force, which urges the valve body 42 towards its first radial position. Accordingly, according to some embodiments, a separate biasing member may not be required.

FIGS. 3a and 3b schematically illustrate cross sections through a pilot valve 40 according to embodiments. The pilot valve 40 is a pilot valve of a centrifugal separator as discussed above with reference to FIGS. 1-2b. Accordingly, in the following reference is also made to FIGS. 1-2b.

Again, the pilot valve 40 is arranged in the rotor body 8 to close and open the operating liquid discharge channel 34. The pilot valve 40 comprises the valve body 42. The valve body 42 is movable in parallel with the longitudinal axis 44 thereof, from a first radial position to a second radial position. The control liquid channel 46 extends to the actuation pressure receiving area 48 of the valve body 42. One portion 46′ of the control liquid channel 46 extends through the valve body 42 to the actuation pressure receiving area 48.

The first radial position of the valve body 42 is shown in FIG. 3a and the second radial position of the valve body 42 is shown in FIG. 3b.

In FIGS. 3a and 3b it is clearly visible how the control liquid channel 46 extends partially through the guide member 50. That is the portion 46′ of the control liquid channel 46 extending through the valve body 42 extends through the guide member 50 to the actuation pressure receiving area 48.

Also, in FIGS. 3a and 3b it is clearly visible how the operating liquid discharge channel 34 extends partially through the guide member 50. From within the rotor body 8, the operating liquid discharge channel 34 leads into the guide member 50 and is directed radially outwardly within the guide member 50. The guide member 50 is provided with one or more outlets 57 for the operating liquid. The outlets 57 for the operating liquid lead to the exterior space 36, as indicated by the broken line arrows in FIG. 3b.

With the valve body 42 in its first radial position, a portion 58 thereof abuts against a sealing surface 60 arranged in the rotor 4. The portion 58 of the valve body 42 and the sealing surface 60 form a sealing interface 62 of the operating liquid discharge channel 34. For instance, an axial end face 64 of the portion 58 of the valve body 42 may be arranged to abut against the sealing surface 60.

The sealing interface 62 sealingly closes the operating liquid discharge channel 34 when the valve body 42 is in the first radial position, see FIG. 3a.

The operating liquid discharge channel 34 leads up to and, when the pilot valve 40 is open, passes the sealing interface 62 to the outlets 57 for operating liquid.

According to some embodiments, along the longitudinal axis 44 of the valve body 42 a ring-shaped recess 66 is provided in the rotor 4 and arranged perpendicularly to the longitudinal axis 44. A resilient ring-shaped element 68 is arranged in the ring-shaped recess 66. The resilient ring-shaped element 68 comprises the sealing surface 60. Thus, the sealing surface 60 may be provided in the rotor 4.

The ring-shaped recess 66 being arranged perpendicularly to the longitudinal axis 44 means that the ring-shaped recess 66 extends circularly around an extension of the longitudinal axis 44.

The ring-shaped recess 66 may be provided in the rotor body 8. Alternatively, the ring-shaped recess 66 may be provided in a separate element fixedly arranged in the rotor body 8.

The resilient ring-shaped element 68 may be made from a natural or a synthetic rubber material.

According to some embodiments, such as the illustrated embodiments, the sealing interface 62 extends in a tangential direction of the rotor 4.

According to embodiments, a control chamber 70 of the pilot valve 40 is configured for receiving the control liquid, the control chamber 70 being delimited in part by the actuation pressure receiving area 48 of the valve body 42. The control liquid channel 46 leads to the control chamber 70.

The control chamber 70 forms that portion of the pilot valve 40, which receives the control liquid when the valve body 42 is to be moved from the first to the second radial position.

The portion 46′ of the control liquid channel 46 extending through the valve body 42 fluidly connects to the control chamber 70.

In the illustrated embodiments, the control chamber 70 is further delimited by the rotor body 8, the guide member 50, and a sleeve or plug 72 extending around a portion of the valve body 42.

According to some embodiments, the control chamber 70 and the actuation pressure receiving area 48 are arranged such that upon supply of control liquid to the control chamber 70 during operation of the centrifugal separator, as a result of an increasing pressure in the control chamber 70 acting on the actuation pressure receiving area 48, the valve body 42 moves from the first radial position to the second radial position to open the operating liquid discharge channel 34.

Accordingly, a volume of the control chamber 70 changes from a smaller volume when the valve body 42 is in the first position to a larger volume as the valve body 42 is in its second position. As the control liquid enters the control chamber 70 and increases the pressure therein, the valve body 42 is displaced by a force caused by the pressure affecting the actuation pressure receiving area 48.

As shown e.g. in FIG. 3a, seen along the longitudinal axis 44 radially inwardly from the pressure receiving area 48, a space 71 is provided in the pilot valve 40 or the rotor body 8. When the valve body 42 moves from its first radial position to its second position, at least a portion of the valve body 42 is displaced into the space 71.

FIG. 4 schematically illustrates a cross section through a portion of a pilot valve 40 of a centrifugal separator according to embodiments.

The centrifugal separator is a centrifugal separator 2 as discussed herein. The pilot valve 40 is configured to operate in a similar manner to that discussed herein with reference to FIGS. 2a-3b.

In these embodiments, the guide member 50 is fixed in relation to the valve body 42 and slidably arranged in relation to the rotor body 8.

Accordingly, instead of the valve body sliding on the guide member as in the previously discussed embodiments, the valve body 42 and the guide member 50 slide together in relation to the rotor body 8.

Still, a portion 46′ of the control liquid channel 46 extends through the valve body 42 and from upstream of the pilot valve 40, the control liquid channel 46 is arranged to connect directly to the portion 46′ of the control liquid channel 46 extending through the valve body 42. Again, the portion 46′ of the control liquid channel 46 extending through the valve body 42 leads to the control chamber 70.

In FIG. 4, the valve body 42 is shown in its second radial position. Control liquid has been admitted to the control chamber 70 and has affected the actuation pressure receiving area 48. The operating liquid discharge channel 34 is opened and the operating liquid can be discharged through the outlet 57 for operating liquid.

A drain channel 74 from the control chamber 70 is provided through the rotor body 8.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the invention, as defined by the appended claims.

1. A centrifugal-separator separator comprising:
a rotor arranged to rotate about a rotational axis having an axial extension, wherein the rotor comprises a rotor body provided with outlet openings arranged at a periphery of the rotor body and an axially movable slide arranged within the rotor body for closing the outlet openings in a first axial position and opening the outlet openings in a second axial position,
wherein a separation space is provided within the rotor,
wherein in the second axial position of the axially movable slide, the outlet openings fluidly connect the separation space with an ambient space outside the rotor,
wherein an operating chamber is provided between the axially movable slide and the rotor body for receiving an operating liquid to displace the axially movable slide from its second axial position to its first axial position, an operating liquid discharge channel extends in the rotor body from the operating chamber to an exterior space of the rotor, a pilot valve is arranged in the rotor body to close and open the operating liquid discharge channel, and a control liquid channel extends at least partially through the rotor body to the pilot valve for supplying a control liquid to the pilot valve,
wherein the pilot valve comprises a valve body having a longitudinal axis, the valve body being movable in parallel with the longitudinal axis from a first radial position to a second radial position under influence of the control liquid,
wherein the control liquid channel extends to an actuation pressure receiving area of the valve body, and
wherein a portion of the control liquid channel extends through the valve body to the actuation pressure receiving area.

2. The centrifugal separator according to claim 1, wherein the control liquid channel extends through the rotor body radially inwardly from the portion of the control liquid channel extending through the valve body.

3. The centrifugal separator according to claim 1, wherein the control liquid channel extends partially through the valve body concentrically with the longitudinal axis of the valve body.

4. The centrifugal separator according to claim 1, further comprising:
a guide member guiding the movement of the valve body between the first and second radial positions.

5. The centrifugal separator according to claim 4, wherein the control liquid channel extends partially through the guide member.

6. The centrifugal separator according to claim 4, wherein the operating liquid discharge channel extends partially through the guide member.

7. The centrifugal separator according to claim 4, wherein the guide member is fixed in relation to the rotor body and comprises a central pin on which the valve body is slidably arranged.

8. The centrifugal separator according to claim 4, wherein the guide member is fixed in relation to the valve body and slidably arranged in relation to the rotor body.

9. The centrifugal separator according to claim 4, wherein the guide member is provided with a through opening fluidly connecting the control liquid channel with the exterior space, wherein the through opening has a smaller cross sectional area than the control liquid channel within the guide member.

10. The centrifugal separator according to claim 1, wherein the valve body is biased towards the first radial position to close the operating liquid discharge channel.

11. The centrifugal separator according to claim 1, wherein a portion of the valve body in its first radial position abuts against a sealing surface arranged in the rotor, and
wherein the portion of the valve body and the sealing surface form a sealing interface of the operating liquid discharge channel.

12. The centrifugal separator according to claim 11, wherein along the longitudinal axis of the valve body a ring shaped recess is provided in the rotor and arranged perpendicularly to the longitudinal axis, and
wherein a resilient ring shaped element is arranged in the ring shaped recess, and wherein the resilient ring shaped element comprises the sealing surface.

13. The centrifugal separator according to claim 12, wherein, the sealing interface extends in a tangential direction of the rotor.

14. The centrifugal separator according to claim 1, wherein a control chamber of the pilot valve is configured for receiving the control liquid, the control chamber being delimited in part by the actuation pressure receiving area of the valve body, and
wherein the control liquid channel leads to the control chamber.

15. The centrifugal separator according to claim 13, wherein the control chamber and the actuation pressure receiving area are arranged such that upon supply of control liquid to the control chamber during operation of the centrifugal separator, as a result of an increasing pressure in the control chamber acting on the actuation pressure receiving area, the valve body moves from the first radial position to the second radial position to open the operating liquid discharge channel.

16. The centrifugal separator according to claim 2, wherein the control liquid channel extends partially through the valve body concentrically with the longitudinal axis of the valve body.

17. The centrifugal separator according to claim 2, further comprising:
a guide member guiding the movement of the valve body between the first and second radial positions.

18. The centrifugal separator according to claim 3, further comprising:
a guide member guiding the movement of the valve body between the first and second radial positions.

19. The centrifugal separator according to claim 5, wherein the operating liquid discharge channel extends partially through the guide member.

20. The centrifugal separator according to claim 5, wherein the guide member is fixed in relation to the rotor body and comprises a central pin on which the valve body is slidably arranged.
